(19) United States
(12) Patent Application Publication
(10) Pub. No.: US 2006/0092966 A1
(43) Pub. Date: May 4, 2006

(54) Internet portal system and method employing handheld device that connects to broadcast source

(75) Inventors: Eran Sitnik, Ossining, NY (US); Yue Ma, West Windsor, NJ (US); Chieh-Chung Chang, Monmouth Junction, NJ (US); Robert S Fish, Gillette, NJ (US)

Correspondence Address: HARNESS, DICKEY & PIERCE, P.L.C., P.O. BOX 828, BLOOMFIELD HILLS, MI, 48303, US

(73) Assignee: MATSUSHITA ELECTRIC INDUSTRIAL CO., LTD, Osaka (JP)

(21) Appl. No.: 10/509,583

(22) PCT Filed: Mar. 31, 2003
(86) PCT No.: PCT/US03/09881

§ 371 Date: Jun. 16, 2005

Related U.S. Application Data
(60) Provisional application No. 60/370,497, filed on Apr. 5, 2002.

(51) Int. Cl. H04L 12/40; H04L 12/66

(52) U.S. Cl. 370/463; 370/438

(57) ABSTRACT

A portal system employs a handheld media delivery device (18) adapted to receive broadcast media content having media content information, adapted to formulate a request based on the media content information, adapted to communicate the request for additional media content to the portal system (23), adapted to receive the additional media content from the portal system (23), and adapted to deliver the additional media content to a consumer (32). The handheld device has a request processor adapted to determine whether a connection to the portal system is available, queue requests locally, and store requests until the connection is available. The portal system includes an input adapted to receive a request for additional media content from the handheld media delivery device (18), and a retrieval mechanism adapted to retrieve additional media content based on the request. An output is adapted to communicate the additional media content to the handheld media delivery device (18), thereby supplementing the media content.

### BACKGROUND OF THE INVENTION

The present invention relates generally to network-based portals that integrate broadcast source information with other information that may have been downloaded to a client device. More particularly, the invention relates to a client-server system for delivery of broadcast information and other information to a handheld device useful in interactive multimedia and interactive television applications.

Current internet portals are designed for computer access, typically through a web-browser. While it is possible to download information about television programs from such a portal, such as in WebTV or Internet TV, the result is not satisfactory primarily due to that fact that either computer screen or Internet screen is intrusively interfering with the viewer watching main TV screen. Current technology provided by Liberate, OpenTV, Wink, Microsoft, IBM, Philips do not provide solutions to this problem. Further, the current technology integrating broadcast source and portal requires consumer to have an Internet connection on at all times. Future interactive television programs are likely to need better portal conductivity than is currently available. The present invention is designed to fill that need.

### SUMMARY OF THE INVENTION

The present invention provides a client-server system where the server functions as an internet portal and the client is deployed on a handheld device. The handheld device functions to download television program-related contents and to upload user data for interactive television applications. Unlike with conventional internet access, the handheld device also communicates with a broadcast source (such as a television broadcast source) to automatically receive program-identifying information that is used to select, for example, the proper internet IP address or addresses for the applicable interactive functions. The program-identified information may consist of simple IP address information or it may comprise more complex collections of data organized in a variety of different data structures including list data structures and nested directory data structures. These more complex data structures allow the user to select among different classes of requests that may be made of the interactive system.

In accordance with the invention, several useful business models are supported. In one embodiment advertisers purchase space on the portal. Because this portal communicates with the client handheld devices, the subscribing advertisers are, in effect, purchasing advertising space that can be placed in the palm of the consumers hand. In another business model consumers subscribe to the portal services and the portal provides premium services and premium information through the handheld device. For a more complete understanding of the invention, its objects and advantages, refer to the remaining specification and to the accompanying drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram illustrating an exemplary embodiment of a system in accordance with the invention;

FIG. 2 is a data flow diagram illustrating how messages are passed between client and server in accordance with the invention;

FIG. 3 is a data structure diagram illustrating one embodiment of a more complex nested directory data structure in accordance with the invention;

FIG. 4 is a block diagram illustrating an exemplary request message handling on handheld and server;

FIG. 5 is a block diagram illustrating an exemplary commerce architecture utilizing a content provider model;

FIG. 6 is a block diagram illustrating an exemplary commerce architecture utilizing a direct-to-customer model;

FIG. 7 is a block diagram illustrating an exemplary commerce architecture utilizing a full-service provider model;

FIG. 8 is a block diagram illustrating an exemplary commerce architecture utilizing a intermediary model;

FIG. 9 is a block diagram illustrating an exemplary commerce architecture utilizing a shared infrastructure model;

FIG. 10 is a block diagram illustrating an exemplary commerce architecture utilizing a value net integrator model;

FIG. 11 is a block diagram illustrating an exemplary commerce architecture utilizing a virtual community model; and

FIG. 12 is a block diagram illustrating an exemplary commerce architecture utilizing a whole-of-enterprise model.

### DETAILED DESCRIPTION OF THE PREFERRED EMBODIMENTS

The following description of the preferred embodiment(s) is merely exemplary in nature and is in no way intended to limit the invention, its application, or uses.

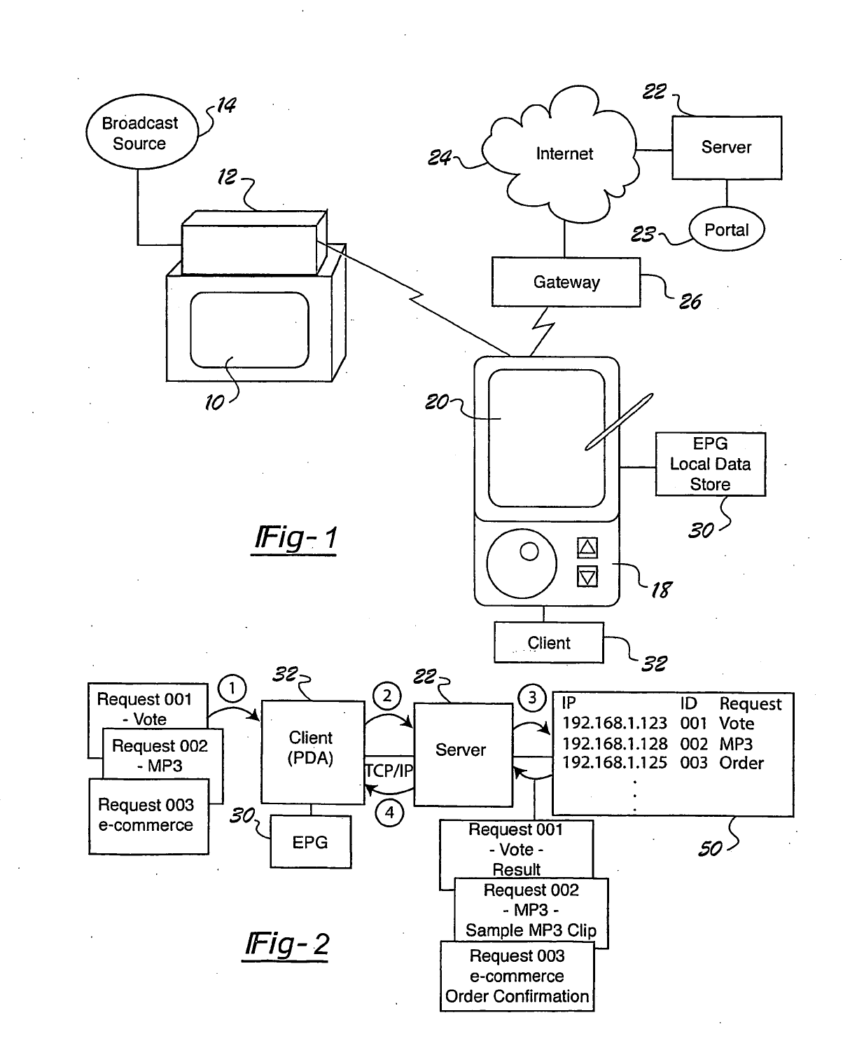

In one presently preferred form the invention defines a system that supplies information to a handheld device from a plurality of disparate sources that are pot conventionally compatible. For example, the system may supply information to the handheld device from a broadcast source of the type normally designed to deliver contents to a television. In addition to that source the system also supplies information from a packet-based delivery system such as a computer network or the internet. Accordingly, one embodiment of such a system may have been illustrated in FIG. 1. Referring to FIG. 1, the television 10 may include a set top box 12 that receives content from a broadcast source 14. The set top box 12 includes a tuner and is also equipped with the ability to communicate wirelessly with the handheld device 18. In the illustrated embodiment the handheld device 18 is a remote control device that may have a touch screen 20 on which the user may view information and also make selections using a suitable stylus 21. The handheld device 18 communicates wirelessly with set top box 12 to receive information from the broadcast source 14. In a digital television application the information destined for the handheld device may be encoded within the digital data stream. In this regard, the MPEG transport stream standard provides for the delivery of such digital content. In an analog television application the information destined for the handheld device 18 may be encoded within the vertical blanking interval (VBI). Optical encoding technology as taught by 4,807,031 to Broughton et al is also well known in the art.

Information is also supplied to the handheld device 18 from another disparate source. In the embodiment illustrated in FIG. 1 this disparate source comprises an internet-based portal. As illustrated, a server 22 which is operating the portal server software module 23 communicates with the internet 24. A suitable gateway device 26 is coupled to the internet and provides wireless connectivity with the handheld device. This way packet-delivered information is supplied to the handheld device 18.

Although the principles of the invention may be extended to a wide variety of different applications, FIG. 1 illustrates a particularly useful application in implementing interactive television features that are not typically found in other systems. The handheld device may have internal memory that is configured as a local data store 30 into which a local copy of selected electronic program guide (EPG) information may be stored. Typically, the EPG information is available from the broadcast source 14 in at least a basic channel-time-program content format. While the available bandwidth within a digital broadcast source is sufficient to deliver more information than the simple EPG data described above, current analog broadcast sources have limited bandwidth for such information and are thus typically restricted to very simple EPG data content, if any. The present invention overcomes this limitation by utilizing additional information obtained from the internet (or from some other source disparate from the broadcast source). The information received from the broadcast source and from the other source (e.g., server 22) is integrated and used by a client application program 32 running on the handheld device 18.

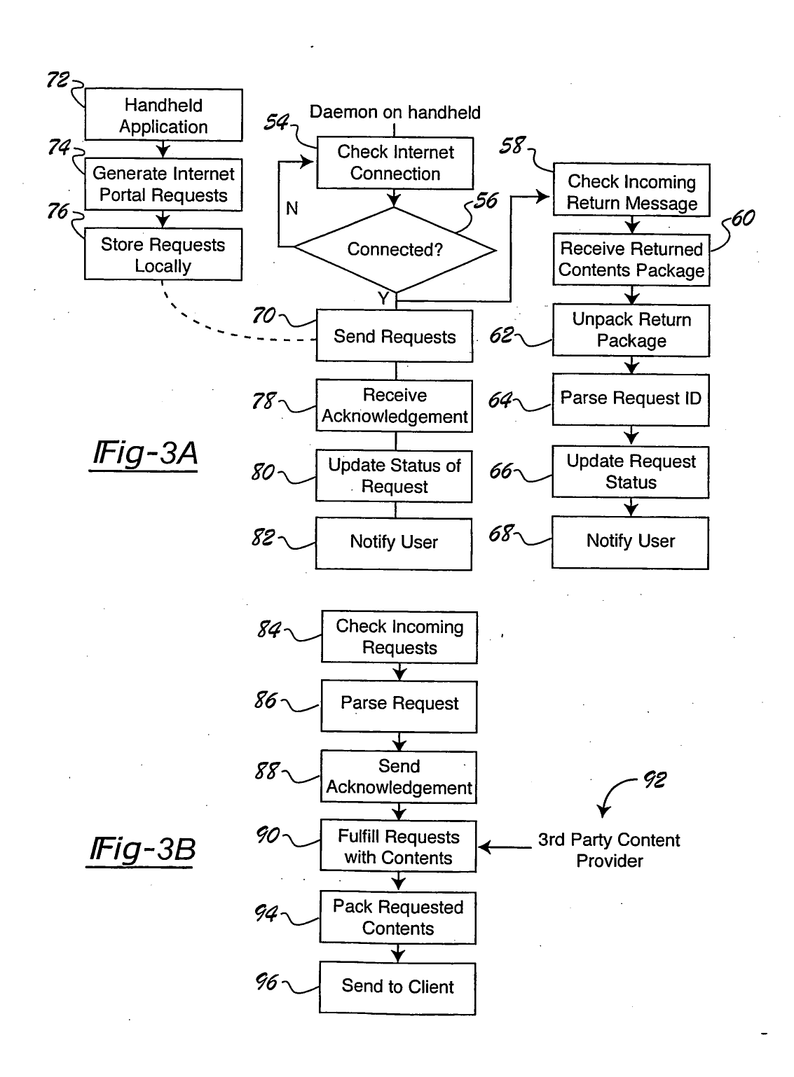

FIG. 2 shows how the client and server interact with one another to provide interactive functionality. Specifically, FIG. 2 shows the client 32 in communication with server 22. The flow of messages may have been labeled by the circled sequence numbers. Note that the client 32 may have locally stored knowledge of basic EPG information contained within data store 30.

Referring to FIG. 2 and proceeding first from left to right, the user of the handheld device enters a series of requests into the handheld device. These requests may be of different types at different times. When a network connection is not available, these requests are made off-line, stored and queued locally on the handheld. Illustrated here are three different request types. Request_001 records the user's vote in response to a query or selection being offered via the broadcast source 14. The offering may be viewed on the television 10 or on the display screen 20 of the handheld device. Request_002 corresponds to a user's request to download a particular selection of additional media content such as an MP3 audio file from the server. Request_003 corresponds to an e-commerce transaction, such as an order placement.

When the network connection to the portal is available, the requests are processed by the client application 32 and then transmitted using the network protocol such as TCP/IP over the internet (not shown) to server 22. It will be appreciated that while the internet presently represents the most convenient mechanism for delivery of packet-based content, other types of networks may also be employed to connect client with server, if desired.

The server 22 processes the request messages sent to it by the client 32 as illustrated at 50. It associates each of the requests with a different IP address, based on criteria such as the request type, the IP address of the client 32, other user-identifying information obtained from client 32 or from some other server, date and time information, and/or combinations thereof. In the illustrated embodiment of FIG. 2 the request type is used to assign the IP address to each request. Server 22 then passes the respective requests to their respective IP addresses where responses are generated as illustrated diagrammatically at 52. These responses are then sent by server 22 (or by other servers in receipt of the requests from server 22) back to client 32 as TCP/IP encoded packets.

FIG. 2 thus illustrates how different types of requests may be divided up at the server and delivered to different systems for processing. In the illustrated embodiment, a server at IP address 192.168.1.123 receives the user's vote and sends back the vote result. The server at 192.168.1.128 handles the user's request for an MP3 file. Similarly, the server at 192.168.1.125 processes the user's e-commerce order and sends back an order confirmation.

Even more sophisticated message processing may be effected by taking into account other information such as the identity of the user and/or date and time information. For example, when the system is used to deliver advertising content via the handheld device, the advertising content may be tailored to different geographic regions based on user-identifying information, the user's gateway IP address, and/or global positioning system (GPS) functionality of the handheld device. Date and time information may be used to control advertising content as well. For example, certain content may be restricted to certain times of day when young children are less likely to be watching, or certain content may be modified depending on the day to correspond with local store sale schedules.

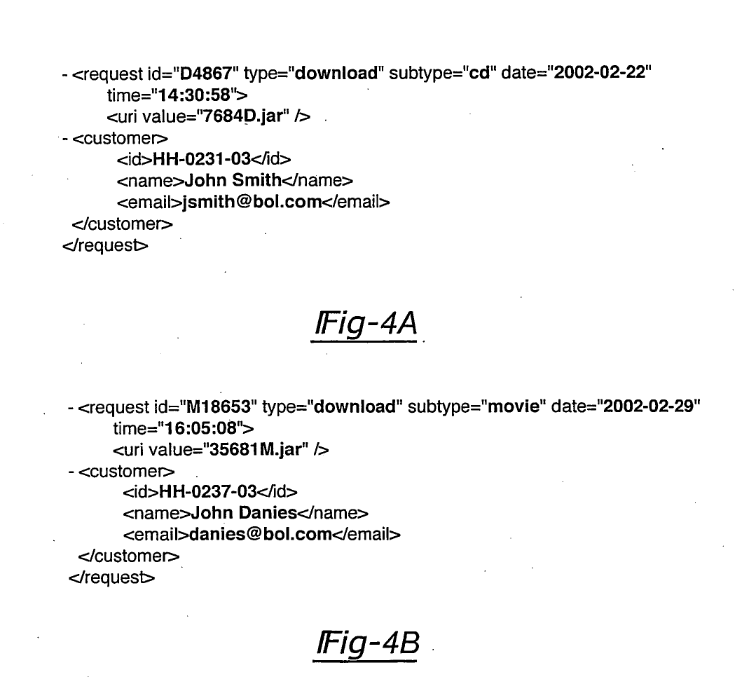

FIG. 4 shows a presently preferred nested data structure for embodying the aforesaid more sophisticated message processing. FIG. 3 shows a presently preferred block diagram for handling these request data at both handheld and server ends. As illustrated in FIG. 3A, where the network connection may not be available, handheld application 72 generates internet portal requests 74, the system stores and queues these request on the handheld device 76. The handheld device is also running a daemon that constantly checks for the Internet connection 54 to the server. As soon as this connection is established 56, stored requests will be sent to the portal for processing 70, receive acknowledgement from the server on the current request 78, update the status of the request 80 and notify user 82 through GUI applications.

In reference to FIG. 3B, on the server side, the system checks incoming requests 84 from the client. Once incoming request is received, the server parses request 86 and send acknowledgement 88 to the client based on the header information in the request. An example of header information includes client ID and network address the request acknowledgement and contents need to be sent to. The server continues to fulfill requests and retrieve requested contents 90. The requested contents may be retrieved from local storage on the server or a 3^{rd} party content provider 92 if necessary. The retrieved contents are packed 94 and send to the client 96.

In continuing reference to FIG. 3A, once network connection is available and requests are pending, the handheld continuously check incoming return message 58 and retrieve returned content packages 60 from the server. Upon the receiving of requested contents, the system unpack the contents 62, parse returned contents for request ID 64. Returned contents will also be parsed and associated with the identified request ID. Then and request status will be updated 66 and notified to the user 68 through GUI applications.

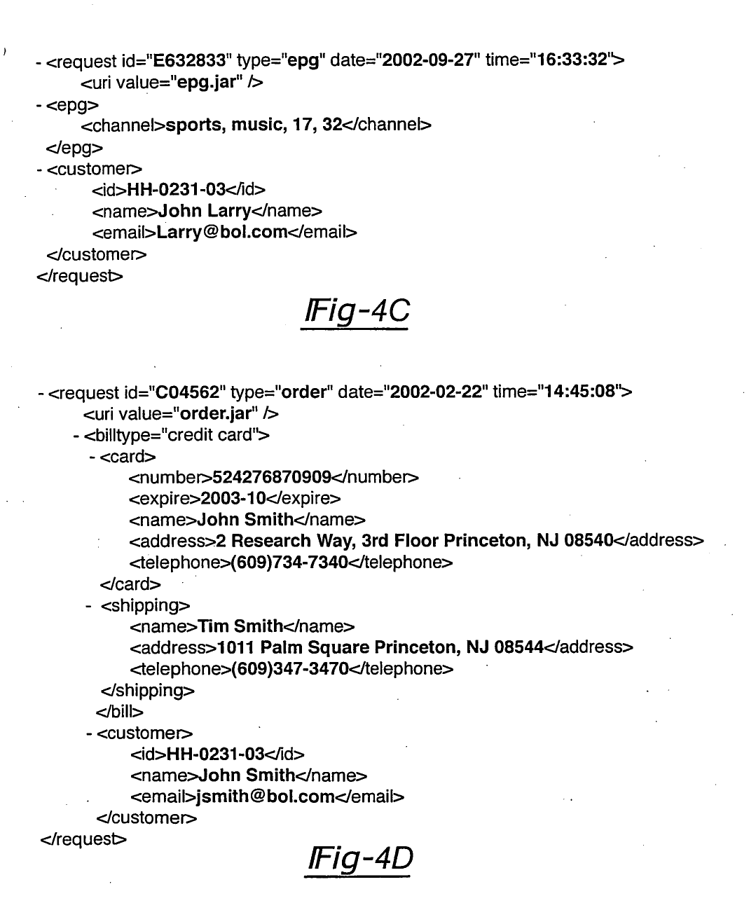

The internet portal system of the invention may be architected in a variety of different ways to achieve different business goals. FIGS. 5-12 illustrate several of these. In each architectural model the broadcast source and server source work together to place interactive capabilities into the user's hand that have not heretofore been achieved. Each of these architecture models affords opportunities for improving message delivery and viewer attention, thereby improving viewership ratings, allowing e-commerce opportunities, and increasing advertising revenues for the content suppliers.

In each of FIGS. 5-12, the end user or users receive information from a broadcast source 14 and also from a portal 23 in accordance with the invention. FIGS. 5-12 illustrate different ways of utilizing the portal to effect different forms of commerce.

FIG. 5 shows a content provider commerce model in which the portal 23 functions as an intermediary service provider. The intermediary service provider obtains content from the content provider and supplies this content to the end user via the handheld device.

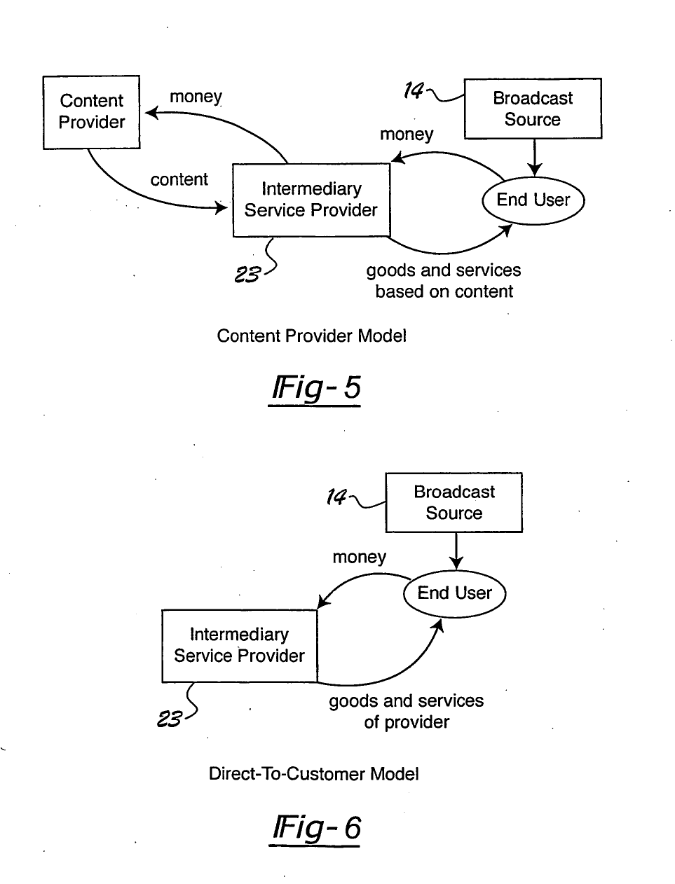

FIG. 6 shows a direct-to-customer commerce model in which the portal 23 serves as the primary supplier of goods and services to the end user via the handheld device.

FIG. 7 illustrates a full service provider commerce model in which the portal 23 provides a plurality of different related or unrelated services to the end user via the handheld device. Portal 23 communicates with a plurality of different sponsors and suppliers by which sponsoring content material and third party goods and services are obtained and delivered to the end user.

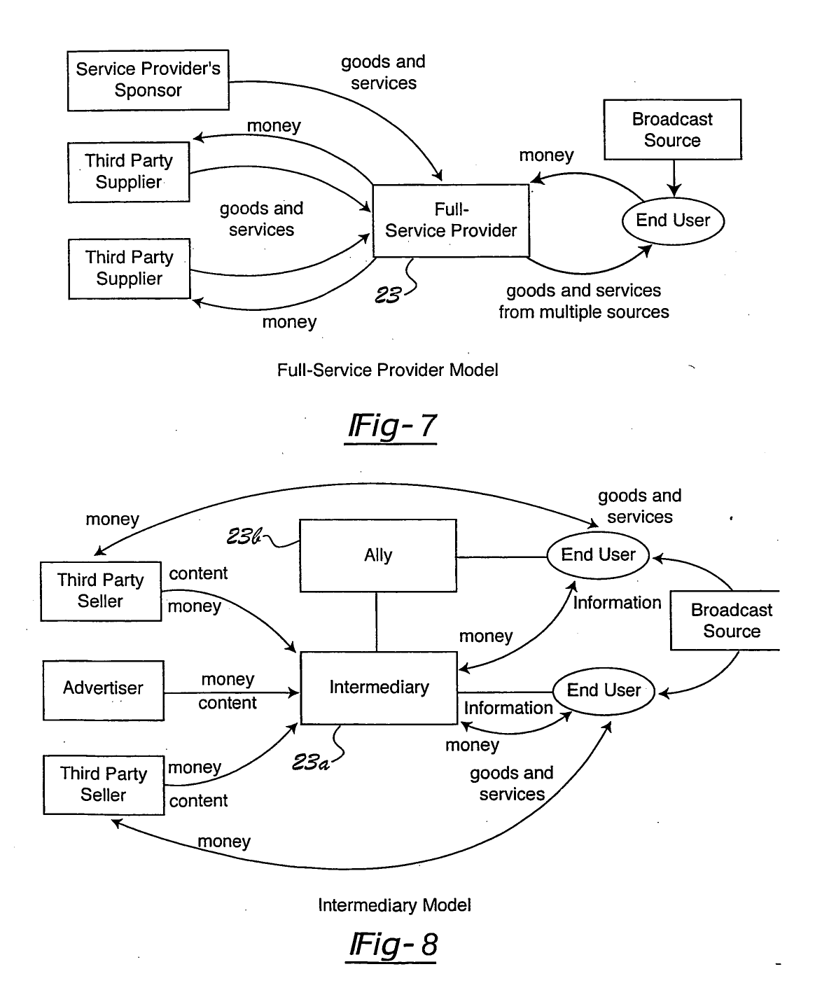

FIG. 8 illustrates the use of the portal in an intermediary commerce model configuration. In this case, an intermediary portal 23a cooperates with an ally portal 23b. The intermediary portal receives content from third party sellers and advertisers, which may also pay the intermediary money as fees for providing the portal service. The intermediary portal delivers information to the end users either directly or through the ally portal 23b via the handheld device. The end users may then transact business either through the intermediary portal 23a or directly with the third party sellers.

FIG. 9 illustrates a shared infrastructure commerce model in which a plurality of suppliers and infrastructure owners cooperate by providing product information to a shared infrastructure portal 23. Customers communicate with the portal 23 via the handheld device to purchase goods and services from the suppliers and owners. If desired, ally portals may also be utilized to effect commerce between customer and owner (or supplier) and between customer and the shared infrastructure portal.

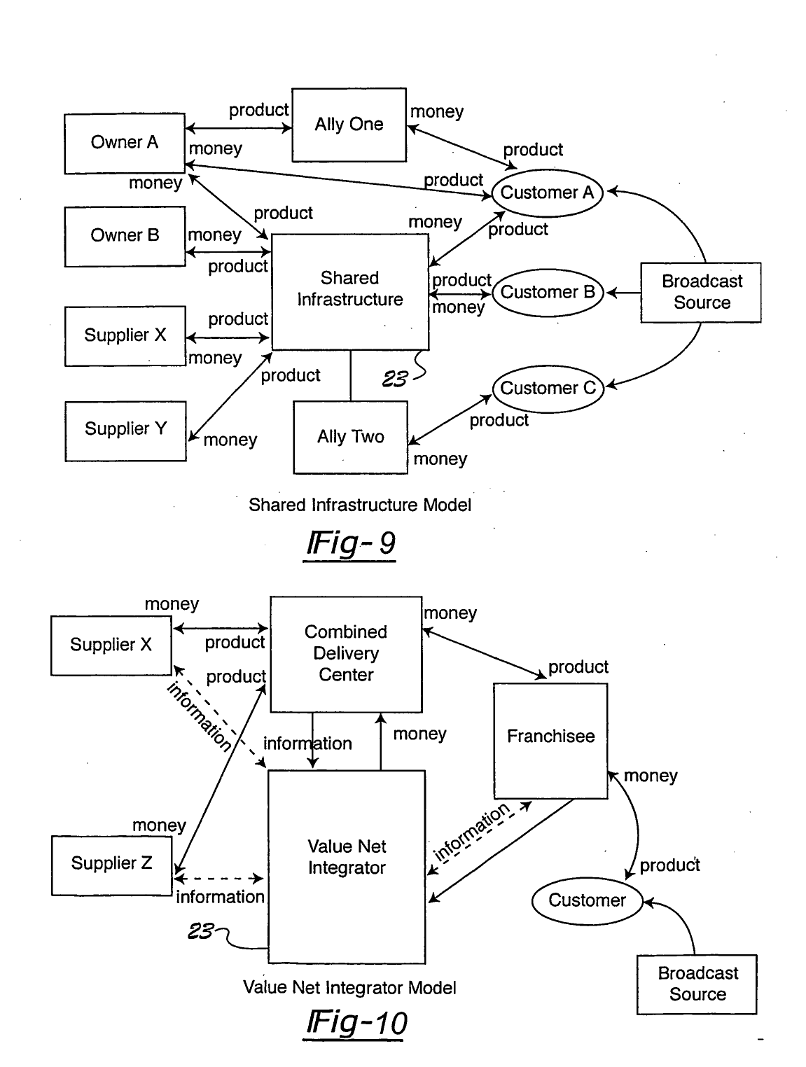

FIG. 10 illustrates a commerce architecture utilizing a value net integrator model as portal 23. The value net integrator assists in managing the businesses of the franchisees by communicating with suppliers to ensure that needed products are developed, supplied, and delivered to the franchisees. The integrator also ensures that advertising and related services are provided in the form of the broadcast source in a manner that allows customers having suitably equipped handheld devices to interact with the franchisees via the handheld devices.

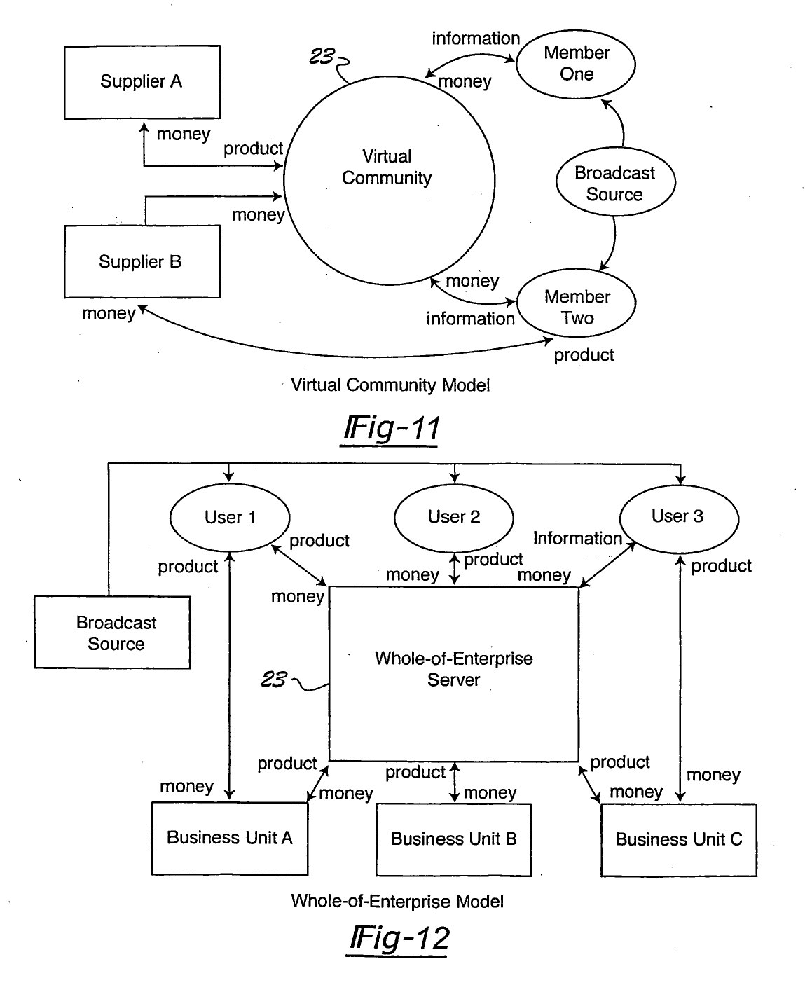

FIG. 11 illustrates a virtual community commerce model to which a plurality of members may belong or subscribe. The virtual community serves as a portal 23 to which suppliers may communicate information about products and services offered. Members access the virtual community portal 23 via the handheld device to exchange information and to transact business with the suppliers.

FIG. 12 illustrates a whole-of-enterprise commerce model that is designed to encapsulate a plurality of functions offered by different business units of an enterprise. The portal server 23 communicates with these business units and makes information about each business unit's products and services available to users via the handheld device. Of course, if desired, the users may access the sites of the business units directly, as illustrated by the lines connecting User 1 and Business Unit A and between User 3 and Business Unit C.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A portal system employing a handheld media delivery device, comprising:
an input adapted to receive a request for additional media content from the handheld media delivery device, wherein the handheld media delivery device is adapted to receive broadcast media content having media content information, adapted to formulate the request based on the media content information, adapted to locally store and queue requests made offline until a connection to the portal is available, adapted to communicate the request for additional media content to the portal system, adapted to receive the additional media content from the portal system, and adapted to deliver the additional media content to a consumer;
a retrieval mechanism adapted to retrieve additional media content based on the request; and
an output adapted to communicate the additional media content to the handheld media delivery device, thereby supplementing the media content.

2. The system of claim 1, comprising a request parser adapted to parse the request.

3. The system of claim 1, wherein said output is adapted to acknowledge the request by sending an acknowledgement to the handheld media delivery device.

4. The system of claim 1, comprising a data packetizer adapted to packetizing the media content.

5. The system of claim 4, wherein said output is adapted to send a packet to the handheld media delivery device.

6. The system of claim 1, wherein said retrieval mechanism is adapted to retrieve the additional media content from local server memory.

7. The system of claim 1, wherein said retrieval mechanism is adapted to retrieve the additional media content from a remote location via a communication system.

8. The system of claim 1, comprising a user profile manager adapted to update a user profile based on the request.

9. The system of claim 8, comprising a back channel adapted to communicate the user profile to a media content provider.

10. The system of claim 9, wherein said input is adapted to receive a request based on media content information targeted to the user profile.

11. A handheld media delivery device adapted to request additional media content from a portal system; comprising:
an input adapted to receive broadcast media content having media content information, and adapted to receive additional media content from a portal system adapted to receive a request from the handheld media delivery device, wherein the portal system is adapted to retrieve additional media content based on the request, and adapted to communicate the additional media content to the handheld media delivery device;
a request processor adapted to formulate the request for additional media content based on the media content information and adapted to locally store and queue requests made offline until a connection to the portal is available;
an output adapted to communicate the request for additional media content to the portal system; and
a user interface adapted to deliver the additional media content to a consumer, thereby supplementing the media content.

12. The device of claim 11, wherein said input is adapted to receive an acknowledgement of the request from the portal system.

13. The device of claim 12, comprising a request status manager adapted to update a status of the request based on the acknowledgment.

14. The device of claim 13, wherein said user interface is adapted to communicate the status of the request to the consumer.

15. The device of claim 11, wherein said request processor is adapted to check an incoming return message.

16. The device of claim 11, wherein said input is adapted to receive additional media content as packetized data.

17. The device of claim 16, wherein said request processor is adapted to unpacketize the packetized data.

18. The device of claim 11, comprising a request parser adapted to parse an identification of the request associated with the additional media content.

19. The device of claim 11, comprising a request status manager adapted to update a status of the request based on receipt of the additional media content.

20. The device of claim 19, wherein said user interface is adapted to communicate the status of the request to the consumer.

21. The device of claim 11, wherein said request processor is adapted to determine whether a connection to the portal system is available, queue requests locally, and store requests until the connection is available.

22. A method of operation for a portal system employing a handheld media delivery device, comprising:
receiving a request for additional media content from the handheld media delivery device, wherein the handheld media delivery device is adapted to receive broadcast media content having media content information, adapted to formulate the request based on the media content information, adapted to locally store and queue requests made offline until a connection to the portal is available, adapted to communicate the request for additional media content to the portal system, adapted to receive the additional media content from the portal system, and adapted to deliver the additional media content to a consumer;
retrieving additional media content based on the request; and
communicating the additional media content to the handheld media delivery device, thereby supplementing the media content.

23. The method of claim 22, comprising parsing the request.

24. The method of claim 22, comprising acknowledging the request by sending an acknowledgement to the handheld media delivery device.

25. The method of claim 22, comprising packetizing the media content.

26. The method of claim 25, wherein said communicating includes sending a packet to the handheld media delivery device.

27. The method of claim 22, wherein said retrieving includes retrieving the additional media content from local server memory.

28. The method of claim 22, wherein said retrieving includes retrieving the additional media content from a remote location via a communication system.

29. The method of claim 22, comprising updating a user profile based on the request.

30. The method of claim 29, comprising communicating the user profile to a media content provider.

31. The method of claim 30, wherein said receiving a request includes receiving a request based on media content information targeted to the user profile.

32. A method of operation for a handheld media delivery device adapted to request additional media content from a portal system; comprising:
receiving broadcast media content having media content information;
formulating a request for additional media content based on the media content information;
locally storing and queueing requests made offline until a connection to the portal is available;
communicating a request for additional media content to a portal system adapted to receive the request from the handheld media delivery device, adapted to retrieve additional media content based on the request, and adapted to communicate the additional media content to the handheld media delivery device;
receiving the additional media content from the portal system; and
delivering the additional media content to a consumer, thereby supplementing the media content.

33. The method of claim 32, comprising receiving an acknowledgement of the request from the portal system.

34. The method of claim 33, comprising updating a status of the request based on the acknowledgment.

35. The method of claim 34, comprising communicating the status of the request to the consumer.

36. The method of claim 32, wherein said receiving the additional media content includes checking an incoming return message.

37. The method of claim 32, wherein said receiving the additional media content includes receiving packetized data.

38. The method of claim 37, wherein said receiving the additional media content includes unpacketizing the packetized data.

39. The method of claim 32, wherein said receiving the additional media content includes parsing an identification of the request associated with the additional media content.

40. The method of claim 32, wherein said receiving the additional media content includes updating a status of the request based on receipt of the additional media content.

41. The method of claim 40, wherein said receiving the additional media content includes communicating the status of the request to the consumer.

42. A method of advertising, comprising:
disseminating advertising information to a consumer while concurrently delivering reward information to a portable device controlled by said consumer and adapted to locally store and queue requests made offline until a connection to a portal is available, said reward information inducing the consumer to give attention to said advertising information.

43. The method of claim 42 wherein said reward information is an electronic coupon.

44. The method of claim 42 wherein said reward information is extra information about the advertising information.

45. The method of claim 42 wherein said advertising information is disseminated from a broadcast source.

46. The method of claim 42 wherein said reward information constitutes additional advertising information.

47. The method of claim 42 wherein said reward information is stored in said portable device for review by the consumer after said advertising information has been disseminated.
